(19) United States
(12) Patent Application Publication
(10) Pub. No.: US 2006/0099972 A1
(43) Pub. Date: May 11, 2006

(54) Method and apparatus for paging an idle mobile unit in a distributed network

(76) Inventors: Sureshbabu P. Nair, Whippany, NJ (US); Ajay Rajkumar, Morristown, NJ (US); Michael D. Turner, Madison, NJ (US)

Correspondence Address: WILLIAMS, MORGAN & AMERSON, 10333 RICHMOND, SUITE 1100, HOUSTON, TX, 77042, US

(21) Appl. No.: 11/209,904

(22) Filed: Aug. 23, 2005

Related U.S. Application Data
(63) Continuation-in-part of application No. 10/984,020, filed on Nov. 8, 2004.

(51) Int. Cl. H04Q 7/20

(52) U.S. Cl. 455/458

(57) ABSTRACT

The present invention provides a method of wireless telecommunication in a network comprised of an inactive mobile unit, a plurality of gateways, and a plurality of base stations associated with the gateways. The method may include receiving information indicative of a first base station associated with a first gateway in response to the inactive mobile unit being located in the region covered by the first base station.

### CROSS REFERENCE TO RELATED APPLICATIONS

This application is a continuation-in-part of U.S. patent application Ser. No. 10/984,020, filed on Nov. 8, 2004 and entitled, “Method and Apparatus for Activating a Dormant Mobile Unit in a Distributed Network.”

### BACKGROUND OF THE INVENTION

1. Field of the Invention

This invention relates generally to a telecommunication system, and, more particularly, to a wireless telecommunication system.

2. Description of the Related Art

In conventional wireless telecommunications, one or more mobile units may establish a wireless link to a Radio Access Network (RAN). The RAN architecture is typically hierarchical and call state information associated with each mobile unit call session is stored in a central repository, such as a Radio Network Controller (RNC), a Packet Data Serving Node (PDSN), and the like. If the user of the mobile unit changes geographical location while the mobile unit is dormant, a paging process may be used to locate the mobile unit. For example, the paging process may be initiated when data intended for the mobile unit arrives at a radio network controller. Upon receiving the page, the mobile unit may transmit an identifier, such as a Unicast Access Terminal Identifier (UATI), which may be used to locate the appropriate call state information in the central repository. The mobile unit may also re-activate the dormant session, in which case the UATI is transmitted and used to locate the appropriate call state information in the central repository.

A first alternative to the conventional hierarchical network architecture is a distributed architecture including a network of base station routers. For example, each base station router may combine RNC and/or PDSN functions in a single entity that manages radio links between one or more mobile units and an outside network, such as the Internet. Compared to hierarchical networks, distributed architectures have the potential to reduce the cost and/or complexity of deploying the network, as well as the cost and/or complexity of adding additional wireless access points, e.g. base station routers, to expand the coverage of an existing network. Distributed networks may also reduce (relative to hierarchical networks) the delays experienced by users because packet queuing delays at the RNC and PDSN of hierarchical networks may be reduced or removed.

In a distributed architecture, one or more mobile units may establish a call session with any one of the plurality of base station routers. Accordingly, each base station router should be capable of assigning an identifier, such as a UATI, to the mobile unit. For example, a proposed Code Division Multiple Access (CDMA) protocol standard, sometimes referred to as the EVolution-Data Only (EVDO) standard, specifies a unique 128-bit UATI that is assigned to a mobile unit when a call session is initiated by the mobile unit. The mobile unit maintains the UATI for the duration of the call session. In the current implementation, the EVDO call session UATI is divided into two parts: a 104-bit UATI104 and a 24-bit UATI024. The UATI024 portion is unique to the mobile unit for the duration of the call session and the UATI 104 is common to all mobile units within a predetermined subnet of base station routers in the distributed network.

In operation, base station routers in a conventional distributed network broadcast, or advertise, their subnet address, e.g. the address indicated by the UATI104 portion of the UATI. However, the address is generally too long to advertise on a control channel, so the base station routers advertise an 8-bit alias to the subnet address called a color code. Mobile units may then determine whether or not the subnet including the base station router providing service to the mobile unit has changed by monitoring the advertised color code on the control channel. If the mobile unit detects a change in the color code, the mobile unit is typically required to request a new UATI. For example, a mobile unit may initiate a call session with a first base station router belonging to a first subnet having a first color code. The first base station router assigns a UATI to the mobile unit. If the mobile unit becomes dormant and later re-activates by sending a message to a second base station router belonging to a second subnet having a second color code, the mobile unit should request a new UATI from the second base station router.

However, the base station routers may have difficulty locating call session information associated with the dormant call session when the dormant mobile unit is re-activated. For example, after a mobile unit may initiate a call session with a first base station router, the mobile unit may be handed off to a second base station router, which may also receive and store the associated call state information. If the mobile unit then becomes dormant and later re-activates by sending a message to a third base station router, the third bas station router may not be able to locate the call session information stored on the second base station router.

In a second embodiment of a distributed communication system, base stations in the distributed communication system are divided into Paging Groups. A Paging Controller is responsible for locating mobile units in the distributed communication network and for maintaining information on the network attachment. In one embodiment, the Paging Controller functionality may be distributed and reside within a last serving WiMAX router before the mobile unit entered idle mode. If there is incoming traffic intended for the mobile unit, the paging of the mobile unit is restricted to the last known Paging Group in which the mobile unit was located. Thus, the mobile unit may be required to update the network with the information indicating the current Paging Group because the network pages the mobile unit only within the last known Paging Group.

The Paging Controller may monitor the mobile unit to determine whether or not the mobile unit is still alive. In one embodiment, a location update process defined in the IEEE 802.16e standard serves as an indication that the mobile unit is still alive and that the context information should be kept at the Paging Controller. The mobile unit may inform the Paging Controller of its new Paging Group when it moves across Paging Group boundaries. The mobile unit may be required to transmit a location update message periodically as it moves within a Paging Group. The location update procedure is done through a ranging request and ranging response exchange between the mobile unit and a target base station, which may then become the preferred base station. States associated with the mobile unit may be moved when forward link and/or reverse link traffic resumes and the mobile unit leaves the idle mode.

The mobile unit may exit idle mode after a network initiated network re-entry. In one embodiment, when forward link data packets destined for the mobile unit arrive at a foreign agent located at the last serving WiMAX router, the Paging Controller initiates the paging procedure and sends paging request messages to all the base stations in the Paging Group of the mobile unit in question through backhaul messages. The Paging Controller may not necessarily be a member of this Paging Group. All the base stations in the Paging Group, upon reception of the paging request, send a broadcast paging message containing the mobile unit's MAC address over the common broadcast paging connection during their next available broadcast paging interval. Upon reception of the paging request message, the mobile unit may send a ranging request message to its preferred base station. This ranging request message contains both the mobile unit's MAC address and a Paging Controller ID. The preferred base station, upon reception of the ranging request message, may send a paging response message to the Paging Controller indicating that the mobile unit location has been found. At that time, the preferred base station may acquire the state information for the mobile unit from the last serving WiMAX router and initiate the network re-entry procedure.

Alternatively, the mobile unit may trigger the exit from idle mode and the network re-entry procedure. For example, the mobile unit may trigger the exit from idle mode if the mobile unit detects the presence of reverse link data traffic. In that case, the mobile unit may send a ranging request message to its preferred base station. In one embodiment, the ranging request message may include the MAC address of the mobile unit, as well as the Paging Controller ID. The preferred base station may then use the Paging Controller ID to locate the last serving WiMAX router associated with the mobile unit and acquire the call session state information associated with the mobile unit. From that point on, the network re-entry procedure may proceed in a matter that is similar to the one described above for the network initiated re-entry.

However, associating the idle mobile unit with Paging Groups as it moves through the distributed communication network may have a number of drawbacks. For example, if the Paging Controller is keeping track of the Paging Group associated with the idle mobile unit, the Paging Controller has to send paging request messages to all the WiMAX routers in the target Paging Group to initiate a page. Consequently, the Paging Controller must be aware of all the WiMAX routers in the target Paging Group and, in a distributed network, all the Paging Controllers must be aware of all the WiMAX routers in the network. Providing this awareness in a constantly changing network deployment scenario is a difficult task, and so modification of the network (including deployment of new routers, de-activation of old routers, and/or reconfiguration of existing routers) may be limited. Furthermore, if the mobile unit is near an edge of a Paging Group boundary, neighboring WiMAX routers in neighboring Paging Groups should also be used to page the mobile unit. However, many of the WiMAX routers in neighboring Paging Groups may not be proximate the mobile unit, and so paging the mobile unit using all the WiMAX routers in these neighboring Paging Groups may waste scarce communication resources.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for wireless telecommunication in a network comprised of an inactive mobile unit, a plurality of gateways, and a plurality of base stations associated with the gateways. The method may include receiving information indicative of a first base station associated with a first gateway in response to the inactive mobile unit being located in the region covered by the first base station.

In another embodiment of the present invention, a method is provided for wireless communication in a network comprised of an inactive mobile unit, a plurality of gateways, and a plurality of base stations associated with the gateways. The method may include providing information indicative of a first base station associated with a first gateway in response to the inactive mobile unit being located in the region covered by first base station.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a distributed wireless telecommunication system, in accordance with the present invention;

FIG. 2 conceptually illustrates a call session identifier that may be used in the distributed wireless telecommunication system shown in FIG. 1, in accordance with the present invention;

FIG. 3 conceptually illustrates one embodiment of a method of migrating information prior to dormancy of a call session, in accordance with the present invention;

FIG. 4 conceptually illustrates a first embodiment of a method of re-activating a dormant call session, in accordance with the present invention;

FIG. 5 conceptually illustrates a second embodiment of a method of re-activating a dormant call session, in accordance with the present invention;

FIG. 6 conceptually illustrates a second exemplary embodiment of a distributed wireless communication system, in accordance with the present invention;

FIG. 7 conceptually illustrates one exemplary embodiment of a method for updating a location of a mobile unit, in accordance with the present invention;

FIG. 8 conceptually illustrates one exemplary embodiment of a method for paging an inactive mobile unit, in accordance with the present invention; and

FIG. 9 conceptually illustrates a third exemplary embodiment of a distributed wireless communication network, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, an air interface, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

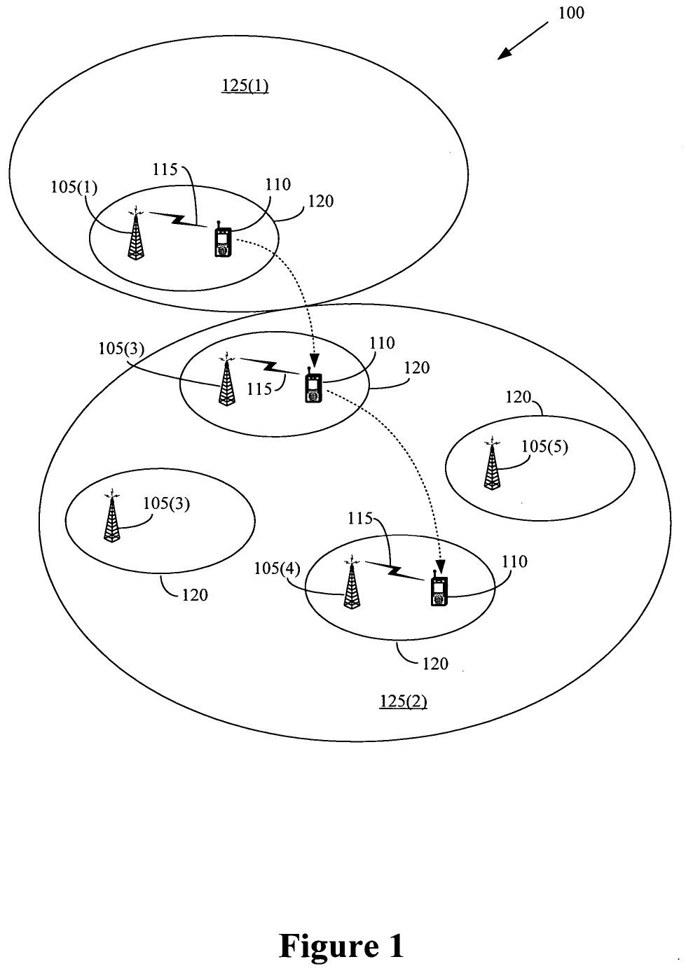

FIG. 1 conceptually illustrates a first exemplary embodiment of a distributed wireless telecommunication system 100. In the illustrated embodiment, access points for the distributed wireless telecommunication system 100 include a distributed network of base station routers 105(1-5). Hereinafter, in the interest of clarity, the base station routers 105(1-5) will be referred to collectively by the numerical identifier 105 unless the description is referring to a specific base station router 105, such as the base station router 105(1). This same convention will be applied to all numerical identifiers used to refer to elements described herein. Although the present invention will be described in the context of the distributed wireless telecommunication system 100 comprising a plurality of base station routers 105, persons of ordinary skill in the art should appreciate that the present invention is not limited to distributed wireless telecommunication systems 100 in which the access points are base station routers 105. In alternative embodiments, the distributed wireless telecommunication system 100 may include any desirable number and/or type of access point.

Each of the base station routers 105 may be capable of initiating, establishing, maintaining, transmitting, receiving, terminating, or performing any other desired action related to a call session with one or more mobile units, such as the mobile unit 110 shown in FIG. 1. For example, each base station router 105 may combine Radio Network Controller (RNC) and Packet Data Serving Node (PDSN) functions in a single entity. The base station routers 105 may also be configured to communicate with other base station routers 105, other devices, other networks, and the like in a manner known to persons of ordinary skill in the art. In some embodiments, base station routers 105 may include both base station functionality and gateway functionality. Accordingly, the base stations and/or gateways described herein may refer to base stations and/or gateways implemented as separate entities, or base stations and/or gateways that are implemented in a base station router 105.

The base station routers 105 provide wireless telecommunication links 115 to mobile units 110 within an associated geographic region, referred to hereinafter as a cell 120. Subsets of the base station routers 105 in the distributed wireless telecommunication system 100 may also be grouped into subnets 125(1-2). Each subnet 125(1-2) includes a subset of the base station routers 105, which provide wireless telecommunication links 115 to a subset of the cells 120. The subnets 125(1-2) have a subnet address, such as a 104-bit UATI address, and may also have an 8-bit alias to the subnet address called a color code. In the interest of clarity, only two subnets 125(1-2) having one and four base station routers 105, respectively, have been depicted in FIG. 1. However, persons of ordinary skill in the art should appreciate that the present invention is not limited to this illustrative exemplary embodiment. In alternative embodiments, any desirable number of subnets 125 including any desirable number of base station routers 105 may be used.

Each base station router 105 can create, assign, transmit, receive, and/or store information related to the call sessions established between the base station routers 105 and the one or more mobile units 110. This information will be collectively referred to hereinafter as call session state information, in accordance with common usage in the art. For example, the call session state information may include information related to an air interface protocol, one or more sequence numbers, a re-sequencing buffer, and the like. The call session state information may also include information related to a Point-to-Point Protocol (PPP), such as header compression information, payload compression information, and related parameters. Call session state information related to other protocol layers may also be created, transmitted, received, and/or stored by the base station routers 105. In one embodiment, the call session state information includes a call session identifier, such as a Unicast Access Terminal Identifier (UATI).

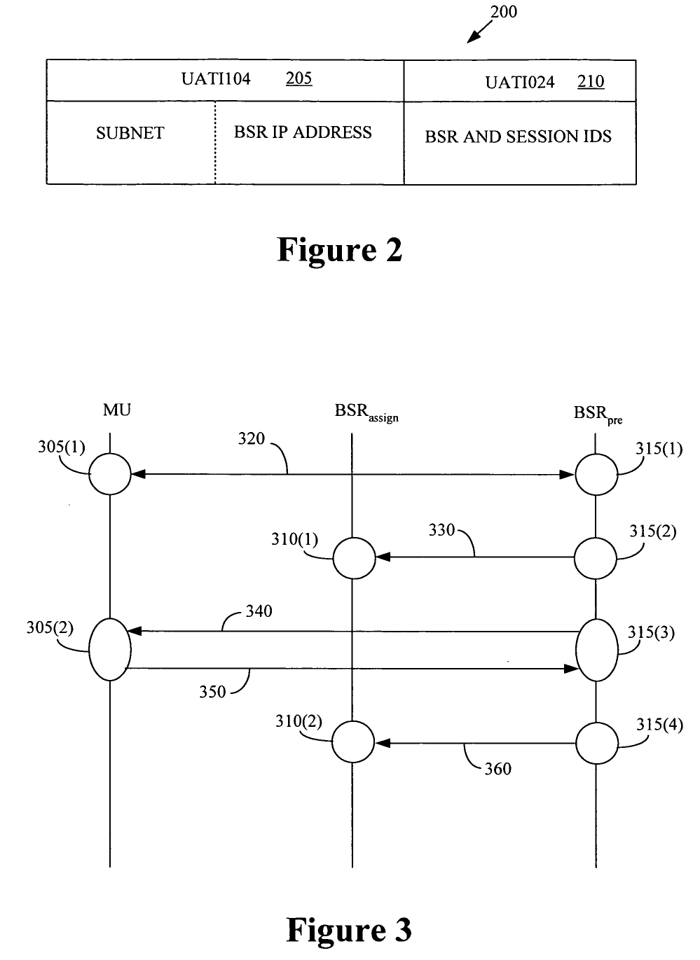

FIG. 2 conceptually illustrates a call session identifier 200 that may be used in the wireless telecommunication system 100 shown in FIG. 1. In the illustrate embodiment, the call session identifier 200 is a UATI that includes a UATI104 portion 205 having 104 bits and a UATI024 portion 210 having 24 bits. The illustrated UATI104 portion 205 includes a 72-bit subnet identifier 215 and a 32-bit base station router IP address. The illustrated UATI024 portion 210 includes a 12-bit base station router identifier that is unique within a subnet or color code and a 12-bit call session identifier. In one embodiment, the UATI024 portion 210 and a color code uniquely identifies a call session within the distributed wireless telecommunication system 100. Persons of ordinary skill in the art should appreciate that the present invention is not limited to this specific embodiment of a UATI call session identifier 200. In alternative embodiments, any desirable call session identifier 200 having any desirable structure and/or number of bits may be used.

In the illustrated embodiment, the 12 call session bits in the UATI024 may represent up to 4096 call sessions, which may include active and/or dormant call sessions. The 12 base station router identifier bits may represent up to 4096 base station routers within a subnet or color code. Accordingly, as will be discussed in detail below, when a mobile unit moves from a first (serving) base station to a second (target) base station within the same subnet or color code, the target base station router may identify the serving base station router using the UATI024 portion 210. The target base station router may then retrieve call session information from the serving base station router.

In one embodiment, the 8-bit color code and the 24-bit IP address in the UATI 104 portion 205 may be transmitted to one or mobile units in a sector parameter message. The mobile units may reject these messages if the relevant portions of the UATI and the sector parameter message do not match. Thus, logical IP addresses and color codes may be used in the UATI104 portion 205. The logical IP addresses may be different than the actual IP address of the base station router, so a translation table may be used to arrive at the actual IP address of a base station router. In one alternative embodiment, a range of numerical values may be used in place of the bit-based base station router identifier. This approach may allow for a more flexible range and more efficient use of the available bits.

Referring back to FIG. 1, operation of one exemplary embodiment of the distributed wireless telecommunication system 100 will now be described. A call session is established between the mobile unit 110 and the base station router 105(1). As part of the establishment procedure, the base station router 105(1) assigns a call session identifier to the call session. As discussed above, the call session identifier may be a UATI. For example, the call session identifier may be a UATI that includes a 104-bit UATI104 having a 72-bit subnet identifier that identifies the subnet 125(1) and a 32-bit IP address for the base station router 105(1). The UATI024 may include a 12-bit identifier indicative of the base station router 105(1). The 12-bit identifier indicative of the base station router 105(1) is unique within the subnet 125(1) and/or an 8-bit color code associated with the subnet 125(1). The UATI024 also includes a 12-bit call session identifier that uniquely identifies the call session among other call sessions that may be concurrently established with the base station router 105(1).

After the call session has been established, the mobile unit 110 moves from the cell 120 served by the base station router 105(1) to the cell 120 served by the base station router 105(2). In one embodiment, the base station router 105(2) may re-assign a new UATI to the mobile unit 110, since the base station router 105(2) is in the subnet 125(2), which has a different 8-bit color code than the subnet 125(1). However, re-assignment of the UATI is not always necessary. For example, the mobile unit 110 may move to a base station router (not shown) in the same color code, in which case it may not be necessary to re-assign the UATI. Moreover, in some alternative embodiments, the mobile unit 110 may be in communication with a plurality of base station routers 105, which are usually referred to as an active set. As long as one of the base station routers 105 in the active set has the same color code as the UATI-assigning base station router 105, it may not be necessary to re-assign the UATI. In one embodiment, the call session state information stored on the base station router 105(1) may be migrated to the base station router 105(2).

The call session associated with the mobile unit 110 then becomes dormant. Dormancy refers to the state of the mobile unit 110 after an existing traffic channel between the mobile unit 110 and the base station router 105(2) has been torn down. In various alternative embodiments, dormancy may be triggered by a user powering down the mobile unit 110, silence in a voice communication, the absence of data requiring transmission, and the like. For example, the mobile unit 110 may include a timer that starts when no voice or data is being transmitted or received. If the timer expires, the mobile unit 110 becomes dormant and the traffic channel may be torn down. Prior to becoming dormant, the mobile unit 110 may carry out one or more pre-dormancy activities, which may include migrating information between various base station routers 105.

FIG. 3 conceptually illustrates one embodiment of a method 300 of migrating information prior to dormancy of a call session. In the embodiment shown in FIG. 3, actions associated with a mobile unit (MU) are indicated by the indices 305(1-2), actions associated with an assigning base station router (BSR_{assign}) are indicated by the indices 310(1-2), and actions associated with a pre-dormancy serving base station router (BSRₚᵣₑ) are indicated by the indices 315(1-4). Arrows 320, 330, 340, 350, 360 are indicative of data transmission and/or reception during one or more of the actions 305(1-2), 310(1-2), 315(1-4). Persons of ordinary skill in the art should appreciate that the present invention is not limited to the actions 305(1-2), 310(1-2), 315(1-4). In alternative embodiments, more or fewer actions may take place during pre-dormancy migration.

At actions 305(1) and 315(1), the mobile unit (MU) and the pre-dormant (or primary) base station router (BSRₚᵣₑ) are communicating, as indicated by the arrow 320. Since it is the natural condition for all protocols to attempt to migrate to the serving base station router, i.e. the pre-dormant base station router (BSRₚᵣₑ), information may be migrated to the pre-dormant base station router (BSRₚᵣₑ) prior to going into dormancy so that the pre-dormant base station router (BSRₚᵣₑ) may contain all of the protocols for the call session. However, the call session identifier, such as a UATI, is not typically migrated from the assigning base station router (BSR_{assign}) to the pre-dormant base station router (BSRₚᵣₑ) in conventional migration schemes. Thus, in one embodiment of the present invention, the UATI is migrated from the assigning base station router (BSR_{assign}) to the pre-dormant base station router (BSRₚᵣₑ) prior to dormancy, as described in detail below. Migrating the UATI prior to dormancy may simplify the process of re-activating the dormant call.

At action 315(2), the pre-dormant base station router (BSRₚᵣₑ) provides a signal indicated by the arrow 330. The signal 330 includes a call session identifier, such as a UATI, which may be provided when data-flow has stopped after a dormancy timer has reached a predetermined time-out period. At action 310(1), the assigning base station router (BSR_{assign}), which originally assigned the UATI to the mobile unit MU, receives the signal 330 and logs the identity of the last serving primary BSR, i.e. the pre-dormant base station router (BSRₚᵣₑ).

At action 315(3), the pre-dormant base station router (BSRₚᵣₑ) sends a UATI Assignment message, indicated by arrow 340, to the mobile unit (MU) prior to traffic channel de-allocation. At action 305(2), the mobile unit (MU) receives the UATI Assignment message 340, updates its UATI for the call session, and acknowledges by sending a UATIComplete message back to the pre-dormant base station router (BSRₚᵣₑ), as indicated by the arrow 350. If this sequence completes successfully, the pre-dormant base station router (BSRₚᵣₑ) becomes the assigning base station router (BSR_{assign}).

At action 315(4), one or more messages, indicated by arrow 360, may be sent to the old assigning base station router (BSR_{assign}) telling it that a new UATI has been assigned for this call session. At action 310(2), the old assigning base station router (BSR_{assign}) receives the message 360 and frees the previously assigned UATI. The old assigning base station router (BSR_{assign}) may now allocate the previously assigned UATI to another call session.

Once the pre-dormancy migration 300 is complete, the mobile unit (MU) may become dormant. However, persons of ordinary skill in the art should appreciate that pre-dormancy migration is an optional operation and, in some embodiments, no pre-dormancy migration may occur. For example, the mobile unit (MU) may unexpectedly become dormant due to some unexpected event. Alternatively, some embodiments of the mobile unit (MU) may not be configured to execute a pre-dormancy routine such as described above.

Referring back to FIG. 1, the dormant mobile unit 110 becomes associated with the base station router 105(4). For example, the user may carry the mobile unit 110 into a region serviced by the base station router 105(4). For another example, changing environmental conditions may result in the base station router 105(4) providing superior quality of service to the mobile unit 110. However, since the mobile unit 110 is dormant, the base station router 105(4) may not be aware of the presence of the mobile unit 110. Thus, when the mobile unit 110 is re-activated, the mobile unit 110 provides an identifier indicative of the dormant call session to the base station router 105(4). The base station router 105(4) then uses the call session identifier to identify the base station router 105 that assigned the identifier indicative of the dormant call session. If the call session state information associated with the dormant call has migrated to the base station router 105(2), then the base station router 105(4) may use the identifier to identify the base station router 105(2) directly and may access the call state information on the base station router 105(2). Alternatively, if the call session state information associated with the dormant call has not been migrated to the base station router 105(2), then the base station router 105(4) may identify the base station router 105(1) based on the call session identifier. The base station router 105(1) may then identify the base station router 105(2) that previously provided service to the mobile unit 110 and the base station router 105(4) may access the call session state information on the base station router 105(2). The dormant call session may then be re-activated using the accessed call session state information.

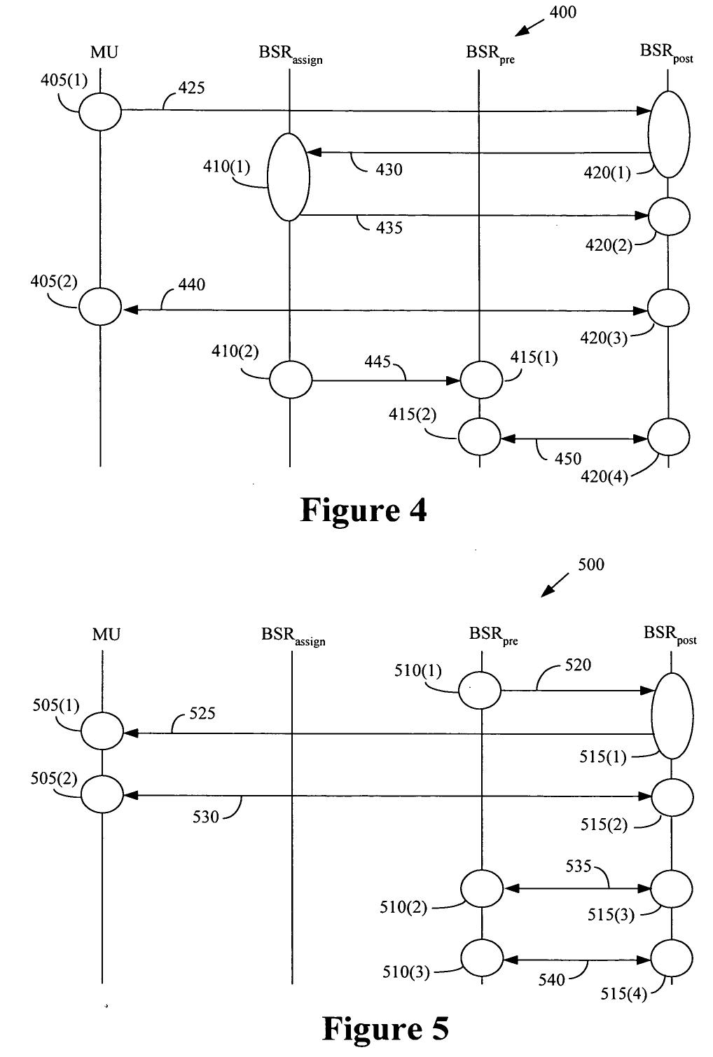

FIG. 4 conceptually illustrates a first embodiment of a method 400 of re-activating a dormant call session. In the embodiment shown in FIG. 4, actions associated with a mobile unit (MU) are indicated by the indices 405(1-2), actions associated with an assigning base station router (BSR_{assign}) are indicated by the indices 410(1-2), actions associated with a pre-dormancy base station router (BSRₚᵣₑ) are indicated by the indices 415(1-2), and actions associated with a post-dormancy base station router (BSRₚₒₛₜ) are indicated by the indices 420(1-4). Arrows 425, 430, 435, 440, 445, 450 are indicative of data transmission and/or reception during one or more of the actions 405(1-2), 410(1-2), 415(1-2), 420(1-4). Persons of ordinary skill in the art should appreciate that the present invention is not limited to the actions 405(1-2), 410(1-2), 415(1-2), 420(1-4). In alternative embodiments, more or fewer actions may take place during re-activation of a dormant call session.

In the first embodiment of the method 400, the mobile unit (MU) initiates re-activation. For example, the mobile unit (MU) may initiate re-activation based upon user input, such as a voice signal, input to a keypad, a power-up sequence, and the like. When the mobile unit (MU) wakes up from dormancy, a call session identifier may be used to find the location of the assigning base station router (BSR_{assign}), which may have call session state information stored thereon. In the illustrated embodiment, the call session identifier is a UATI. However, persons of ordinary skill in the art should appreciate that any desirable call session identifier may be used. Alternatively, some or all of the call session state information may be stored on the pre-dormancy base station router (BSRₚᵣₑ), and the assigning base station router (BSR_{assign}) may have information indicative of the location of the pre-dormancy base station router (BSRₚᵣₑ).

At action 405(1), the mobile unit (MU) initiates traffic channel setup procedure by sending a Connection Request Message, indicated by the arrow 425, to the post-dormancy base station router (BSRₚₒₛₜ). The Connection Request Message includes the UATI associated with the mobile unit (MU). At action 420(1), the post-dormancy base station router (BSRₚₒₛₜ) receives the Connection Request Message 425 including the UATI. Using the UATI, the post-dormancy base station router (BSRₚₒₛₜ) contacts the assigning base station router (BSR_{assign}) to verify the state of the UATI. In one embodiment, the post-dormancy base station router (BSRₚₒₛₜ) contacts the assigning base station router (BSR_{assign}) by sending a message, as indicated by the arrow 430.

At action 410(1), the assigning base station router (BSR_{assign}) determines whether or not the transmitted state of the UATI is valid. If valid, the assigning base station router (BSR_{assign}) sends the address of the pre-dormancy base station router (BSRₚᵣₑ) that served the UATI, as indicated by the arrow 435. At action 420(2), the post-dormancy base station router (BSRₚₒₛₜ) receives the message 435 including the address and prepares to instantiate forward and reverse-link Radio Link Protocols (RLP). In one embodiment, the post-dormancy base station router (BSRₚₒₛₜ) knows to forward any reverse-link packets to PPP at the pre-dormancy base station router (BSRₚᵣₑ).

At actions 405(2) and 420(3), the post-dormancy base station router (BSRₚₒₛₜ) and the mobile unit (MU) complete the traffic channel setup procedure. In the illustrated embodiment, the traffic channel, as well as the signaling used to establish the traffic channel, is indicated by the arrow 440. Where possible, traffic channel setup can occur simultaneously with other signaling. At actions 410(2) and 415(1), the assigning base station router (BSR_{assign}) communicates with the pre-dormancy base station router (BSRₚᵣₑ), as indicated by the arrow 445. In one embodiment, the assigning base station router (BSR_{assign}) tells the pre-dormancy base station router (BSRₚᵣₑ) that the post-dormancy base station router (BSRₚₒₛₜ) is re-activating communication to the mobile unit (MU). The pre-dormancy base station router (BSRₚᵣₑ) receives the message 445 and may then reactivate its protocol stack with the exception that forward and reverse-link RLP may be done at the post-dormancy base station router (BSRₚₒₛₜ). This means that on startup, forward-link user data from PPP may be tunneled directly to the post-dormancy base station router (BSRₚₒₛₜ).

At actions 415(2) and 420(4), forward and reverse-link traffic may be tunneled between the pre-dormancy base station router (BSRₚᵣₑ) and the post-dormancy base station router (BSRₚₒₛₜ), as indicated by arrow 450. The post-dormancy base station router (BSRₚₒₛₜ) may receive the address 450 and prepare to instantiate forward and reverse-link RLP. In one embodiment, the post-dormancy base station router (BSRₚₒₛₜ) knows to forward any reverse-link packets to PPP at the pre-dormancy base station router (BSRₚᵣₑ). At this point, active migration of all BSR protocol states to the post-dormancy base station router (BSRₚₒₛₜ) may begin, as will be described in detail below.

Re-activation of the mobile unit (MU) from dormancy in the above-described manner may reduce the time that may elapse before the mobile unit (MU) is able to receive traffic. In the above described embodiment, the protocol states are reactivated with RLP being done at the post-dormancy base station router (BSRₚₒₛₜ) while all of the other states are done at the pre-dormancy base station router (BSRₚᵣₑ), which last served the call session. Migration of all of the protocol states to the post-dormancy base station router (BSRₚₒₛₜ) may then proceed during the active call session.

FIG. 5 conceptually illustrates a second embodiment of a method 500 of re-activating a dormant call session, in accordance with the present invention. In the second embodiment shown in FIG. 5, actions associated with a mobile unit (MU) are indicated by the indices 505(1-2), actions associated with a pre-dormancy base station router (BSRₚᵣₑ) are indicated by the indices 510(1-3), and actions associated with a post-dormancy base station router (BSRₚₒₛₜ) are indicated by the indices 515(1-4). Arrows 520, 525, 530, 540, 545 are indicative of data transmission and/or reception during one or more of the actions 505(1-2), 510(1-3), 515(1-4). Persons of ordinary skill in the art should appreciate that the present invention is not limited to the actions 505(1-2), 510(1-3), 515(1-4). In alternative embodiments, more or fewer actions may take place during re-activation of a dormant call session.

In the second embodiment of the method 500, the distributed network initiates re-activation. In one embodiment, re-activation is initiated when data intended for the mobile unit (MU) is received by the distributed network. For example, forward-link data arriving from the network may be forwarded to the pre-dormancy base station router (BSRₚᵣₑ), which may initiate a paging process to locate the mobile unit (MU) in response to receiving the forward link data. The paging process will be discussed in greater detail below.

At action 510(1), forward-link data arriving at the pre-dormancy base station router (BSRₚᵣₑ) forces it to initiate the paging process to locate the dormant mobile unit (MU). In one embodiment, the pre-dormancy base station router (BSRₚᵣₑ) sends paging requests, as indicated by arrow 520, to neighboring BSRs according to a paging strategy. Along with the paging request 520, the IP address of the pre-dormancy base station router (BSRₚᵣₑ) is sent along with the associated UATI. In one embodiment, the paging strategy is implemented in a distributed manner in which a paging area consists of a group of neighboring base station routers. When forward link data arrives at the PPP layer on the pre-dormancy base station router (BSRₚᵣₑ), the pre-dormancy base station router (BSRₚᵣₑ) may determine the UATI associated with the mobile unit based upon the forward link data. The pre-dormancy base station router (BSRₚᵣₑ) may then translate the UATI to determine the base station router's IP address and use this address to send page messages to other base station routers in a subnet indicated by a color code in the UATI. In one embodiment, the paging strategy may also include defining one or more subgroups so that paging may be done in an optimal manner without utilizing all of the resources of the pre-dormancy base station router (BSRₚᵣₑ). If the pre-dormancy base station router (BSRₚᵣₑ) is at or near a color code boundary, the paging subgroups could exist in multiple color codes. In alternative embodiment, the paging requests may be sent across color codes.

At action 515(1), the post-dormancy base station router (BSRₚₒₛₜ) receives the paging message 520, which may include the UATI and/or the IP address of the pre-dormancy base station router (BSRₚᵣₑ). The post-dormancy base station router (BSRₚₒₛₜ) then sends a page 525 to the mobile unit (MU). If the mobile unit (MU) responds, the post-dormancy base station router (BSRₚₒₛₜ) knows to direct any reverse-link traffic PPP located at the pre-dormancy base station router (BSRₚᵣₑ). In one embodiment, the post-dormancy base station router (BSRₚₒₛₜ) prepares to instantiate forward and reverse-link RLP.

At action 505(2) and 515(2), the mobile unit (MU) receives a page 530, recognizes its UATI, and initiates the traffic channel setup procedure by sending a Connection Request message (also indicated by the arrow 530) to the post-dormancy base station router (BSRₚₒₛₜ). The post-dormancy base station router (BSRₚₒₛₜ) responds and then the mobile unit MU) and the post-dormancy base station router (BSRₚₒₛₜ) complete the traffic channel setup procedure. Where possible, traffic channel setup can occur simultaneously with other signaling.

At action 515(3), the post-dormancy base station router (BSRₚₒₛₜ) may provide a message 535 to the pre-dormancy base station router (BSRₚᵣₑ) indicating that the post-dormancy base station router (BSRₚₒₛₜ) is reactivating communication to the mobile unit (MU). The message 535 may also inform the pre-dormancy base station router (BSRₚᵣₑ) of the address of the post-dormancy base station router (BSRₚₒₛₜ). At action 510(2), the pre-dormancy base station router (BSRₚᵣₑ) receives the message 535 and reactivates its protocol stack with the exception that forward and reverse-link RLP will be done at the post-dormancy base station router (BSRₚₒₛₜ). This means that on startup, forward-link user data shall be tunneled directly to the post-dormancy base station router (BSRₚₒₛₜ).

At actions 510(3) and 515(4), forward and reverse-link traffic is tunneled between the pre-dormancy base station router (BSRₚᵣₑ) and the post-dormancy base station router (BSRₚₒₛₜ), as indicated by arrow 540. The pre-dormancy base station router (BSRₚᵣₑ) receives the message 540 and reactivates its protocol stack with the exception that forward and reverse-link RLP will be done at the post-dormant BSR. This means that on startup, forward-link user data shall be tunneled directly to the post-dormancy base station router (BSRₚₒₛₜ).

Re-activation of the mobile unit (MU) from dormancy in the above described manner may allow the mobile unit (MU) to receive traffic at the earliest possible time. In the above embodiment, the protocol states are reactivated with RLP being done at the post-dormancy base station router (BSRₚₒₛₜ), which last served the call. Migration of all of the protocol states to the post-dormancy base station router (BSRₚₒₛₜ) can proceed during the active call.

Referring back to FIG. 1, in one alternative embodiment, the mobile unit 110 may determine that a color code associated with the base station router 105(4) has changed while the mobile unit 110 was dormant. For example, the mobile unit 110 may listen on an overhead channel for sector parameters and thereby detect that it is in a new coverage area associated with a new color code. The mobile unit 110 may then transmits its call session identifier to the base station router 105(4), which may determine the address of the base station router 105(2), at least in part based upon the color code of the base station router 105(2) indicated by the call session identifier. The base station router 105(4) may then retrieve call session state information from the base station router 105(2). In one embodiment, the mobile unit 110 may also request reassignment of the call session identifier when it emerges from dormancy.

In one embodiment, an address translation request message/response to any base station router 105 within a color code group may be provisioned in all the base station routers 105 to avoid having to store all the base station router IP addresses in all the base station routers 105 in all color code regions. Accordingly, one base station router may perform address translation request for all the base station routers 105 in a color coded region when a request is received from a base station router 105 in another color coded group. Alternatively, the message/response may be handled by a network management center (not shown). In that case, the network management center may store all the base station router IP addresses for all color coded regions.

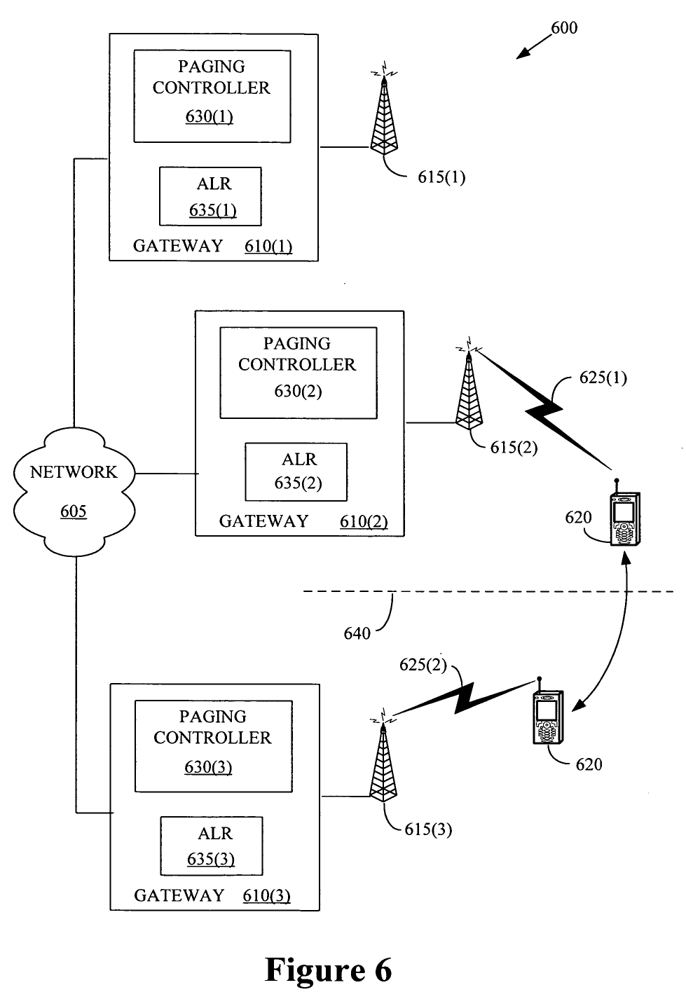

FIG. 6 conceptually illustrates a second exemplary embodiment of a distributed wireless communication system 600. In the illustrated embodiment, the distributed wireless communication system 600 includes a network 605. At least a portion of the network 605 may operate according to an IEEE 802.16 standard and/or a WiMAX standard. However, the present invention is not limited to network that operate according to these standards. In alternative embodiments, portions of the network 605 may operate according to any wired and/or wireless standard. For example, portions of the network 605 may operate according to standards and/or protocols such as Universal Mobile Telecommunication System (UMTS), Global System for Mobile communications (GSM), Code Division Multiple Access (CDMA, CDMA 2000), IEEE 802.11, Bluetooth, and the like. For another example, the network 605 may include a Public Switched Telephone Network (PSTN), a Plain Old Telephone System (POTS), and the like.

One or more gateways 610(1-3) may be communicatively coupled to the network 605. Each gateway 610 is associated with at least one base station 615(1-3), which may provide wireless connectivity to one or more mobile units 620. In one embodiment, each gateway 610 and its associated base station(s) 615 may be implemented in an access-serving network, such as a WiMAX router. However, persons of ordinary skill in the art having benefit of the present disclosure should appreciate that the present invention is not limited to gateways 610 and/or base stations 615 that are implemented in WiMAX routers. The gateways 610 and the base stations 615 may be grouped into paging groups. In the illustrated embodiment, the gateway 610(1), the base station 615 (1), the gateway 610(2), and the base station 615(2) are included in a first paging group. The gateway 610(3) and the base station 615(3) are included in a second paging group. However, persons of ordinary skill in the art should appreciate that the first and/or second paging groups may include more or fewer gateways and/or base stations, and the distributed communication system 600 may include more or fewer paging groups.

The mobile unit 620 may become inactive. In the illustrated embodiment, the mobile unit 620 operates according to the IEEE 802.16 standard, which defines two inactive modes: the sleep mode and the idle mode. However, persons of ordinary skill in the art having benefit of the present disclosure should appreciate that the mobile unit 620 is not limited to the sleep and/or idle modes as defined by the IEEE 802.16 standard. Each gateway 610 may include a paging controller 630(1-3), which administers the inactive mobile unit 620. For example, the paging controllers 630 may administer idle-mode activity. The paging controller 630 may include a register 635(1-3) that may be used to store location state information associated with one or more mobile units 620. In the illustrated embodiment, the registers 635 are Access Serving Network Location (ALR) registers 635 that are used to store location and paging context information associated with the mobile units 620. For example, when the mobile unit 620 transitions from an active data session into an idle mode, the traffic channel 625(1) is torn down and states for maintaining location of the mobile unit 620 are retained in the paging controller 630(2) associated with the last serving (or source) gateway 610(2). Specifically, the paging controller 630(2) may maintain an identifier associated with the mobile unit 620, as well as information indicating the paging controller associated with the last serving base station 615(2). In one embodiment, information indicating the paging group containing the last serving base station 615(2) may also be provided.

The paging controllers 630 may be used to facilitate returning the inactive mobile unit 620 to active state, e.g., from the idle mode. However, the mobile unit 620 may move while it is inactive. For example, the mobile unit 620 may be actively communicating with the base station 615(2) over the wireless communication link 625(1) before becoming inactive. While inactive, the mobile unit 620 may move (or may experience some other change in circumstances) such that the mobile unit 620 moves to a region covered by base station 615(3). Accordingly, the paging controllers 630 should maintain an awareness of the location of the inactive mobile unit 620 as it moves so that when incoming data destined for the mobile unit 620 arrives, e.g. at a Foreign Agent (not shown in FIG. 6) located within the last serving gateway 610(2), the mobile unit 620 can quickly be located and re-enter the active state to receive the data.

Thus, the inactive mobile unit 620 may provide information indicating that the inactive mobile unit 620 has moved to a region covered by base station 615(3). In one embodiment, the mobile unit 620 may transition into an adjacent paging group when it moves during idle mode, e.g., by crossing a paging group boundary 640 between the first and second paging groups. When the mobile unit 620 becomes aware that it has entered a different paging group, a location update procedure may be performed. For example, the 802.16e protocol specifies that a Location Update procedure be performed when the inactive mobile unit 620 enters a new paging group. In one alternative embodiment, the Location Update procedure may originate from the mobile unit 620 periodically, even if the mobile unit 620 has not moved into a new paging group. For example, the mobile unit 620 may initiate a location update procedure in response to expiration of a timer or clock.

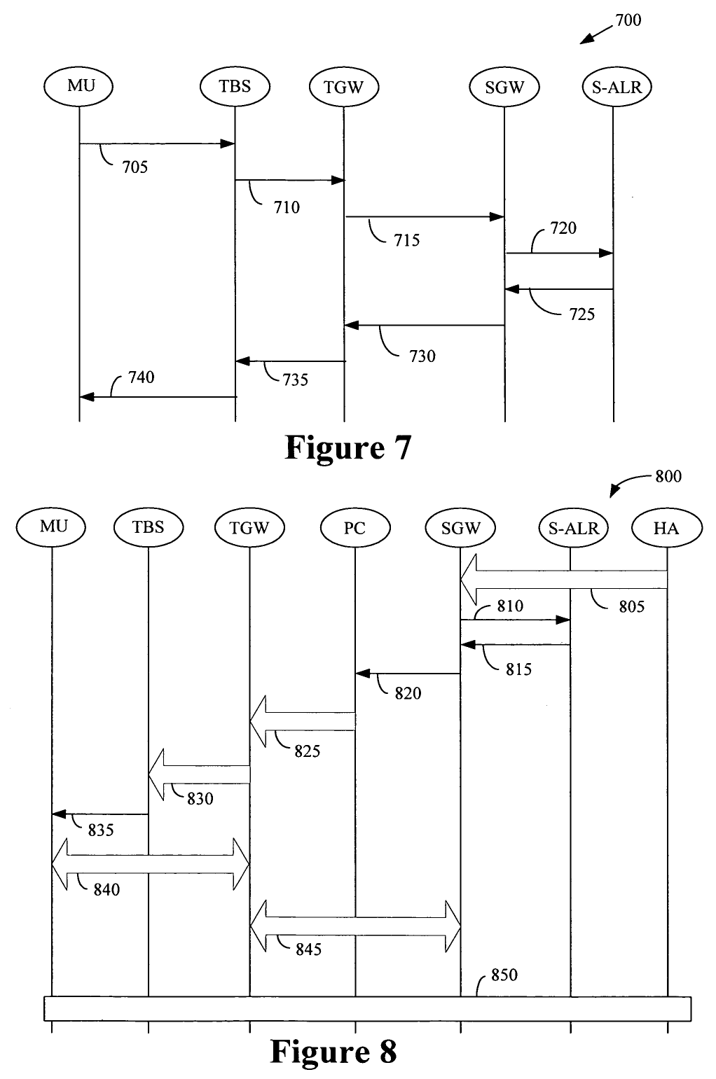

FIG. 7 conceptually illustrates one exemplary embodiment of a method 700 for updating a location of an idle mobile unit (MU), such as the mobile unit 620 shown in FIG. 6. In the illustrated embodiment, the mobile unit (MU) moves out of a region covered by the base station associated with a source gateway (SGW) into a region covered by a target base station (TBS) associated with a target gateway (TGW), which may be in a different paging group. The mobile unit provides (as indicated by the arrow 705) a message including information indicative of the mobile unit (MU) and/or the source gateway (SGW). For example, in the Location Update procedure specified by IEEE 801.16, the mobile unit (MU) may send (at 705) a ranging request (RNG-REQ) message to the target base station (TBS) containing an identifier of a paging controller associated with the source gateway (SGW) and/or a mobile unit identifier. The target base station (TBS) may then provide (as indicated by the arrow 710) this information to the target gateway (TGW), which may use a portion of this information to locate the source gateway (SGW) and provide (as indicated by the arrow 715) information indicative of the location of the mobile unit (MU), the target base station (TBS), and/or the target gateway (TGW) to the source gateway (SGW).

The source gateway (SGW) uses the information provided by the target gateway (TGW) to update a register associated with the source gateway (as indicated by the arrow 720). For example, the source gateway (SGW) may update an ASN Location Register (S-ALR). The source gateway (SGW) may then receive an acknowledgment (as indicated by the arrow 725) from the register (S-ALR) once the location information associated with the mobile unit (MU) has been successfully updated. Information indicative of the source gateway (SGW) may then be provided (as indicated by the arrow 730) to the target gateway (TGW). In one embodiment, information indicating an identity of a paging controller associated with the source gateway (SGW) may be communicated (at 730) to the target gateway (TGW) associated with the target base station (TBS). A location update response may then be provided (as indicated by the arrow 735) the target base station (TBS), which may provide (as indicated by the arrow 740) a ranging response (RNG-RSP) message to the mobile unit (MU).

Referring back to FIG. 6, when the location update procedure has been performed for the inactive mobile unit 620, as discussed above, the register 635(2) includes information indicative of the location of the base station 615(3). For example, the register 635(2) may store a base station identifier associated with the base station 615(3). In one embodiment, the register 635(2) may also include information indicative of the gateway 610(3). In another embodiment, the register may also include information indicative of the paging controller associated with base station 615(3). When information destined for the mobile unit 620 arrives at the gateway 610(2) from the network 605, the paging controller 630(2) accesses the register 635(2) to retrieve the information indicative of the location of the base station 615(3). The paging controller 630(2) may use the information indicative of the location of the base station 615(3) to initiate a page of the inactive mobile unit 620 over the air interface 625(2), as will be discussed in detail below.

FIG. 8 conceptually illustrates one exemplary embodiment of a method 800 for paging an inactive mobile unit (MU). In the illustrated embodiment, data intended for the mobile unit (MU) is provided (as indicated by the arrow 805) to a source gateway (SGW) by a home agent (HA). The source gateway (SGW) accesses (as indicated by the arrow 810) a register, such as an ASN Location Register (S-ALR). For example, the source gateway (SGW) may provide (at 810) a location request for information indicating a location of a target base station (TBS) and/or a target gateway (TGW). The ASN Location Register (S-ALR) may then provide the information indicating a location of a target base station (TBS) and/or a target gateway (TGW), as indicated by the arrow 815. The source gateway (SGW) uses the provided information to provide a paging announcement to a paging controller (PC) associated with the last reporting base station, as indicated by the arrow 820. For example, the source gateway (SGW) may provide a paging announcement (at 820) including a base station identifier of the target base station (TBS). If the last reporting base station is the target base station (TBS), the paging controller (PC) may be associated with the target gateway (TGW). However, if the last reporting base station is not the target base station (TBS), e.g., because the mobile unit (MU) has moved and/or due to other factors such as changing channel conditions, the last reporting paging controller (PC) may be associated with another gateway.

The last reporting paging controller (PC) provides one or more paging announcements to one or more gateways, as indicated by the arrow 825. In one embodiment, the last reporting paging controller (PC) uses the information indicative of the target base station (TBS) and/or the target gateway (TGW) to provide the paging announcement to the target base station (TBS) and/or the target gateway (TGW). In one alternative embodiment, the last reporting base station may not be the target base station (TBS). Accordingly, the last reporting paging controller (PC) may use the information indicative of the last reporting base station and/or the last reporting gateway to provide the paging announcement to one or more gateways that are associated with one or more base stations that are proximate the last reporting base station. In one embodiment, the one or more gateways may include gateways associated with all base stations within the same paging group as the last reporting base station.

The gateways that receive the paging announcement (at 825) may provide the paging announcement to at least one associated base station, as indicated by the arrow 830. The base stations that receive the paging announcement may then page the mobile unit (MU), as indicated by the arrow 835. Since the paging announcement is provided (at 830) to the target base station (TBS) and/or base stations near the last reporting base station, the probability that the mobile unit (MU) may receive the page may be increased, even if the mobile unit (MU) has moved and/or other factors such as changing channel conditions have caused the mobile unit (MU) to change to a target base station (TBS) that is different from the last reporting base station. Upon receiving the paging announcement, the mobile unit (MU) may initiate network reentry procedures, as indicated by the arrow 840. In one embodiment, the network reentry procedures may include providing a ranging request message to the target base station (TBS) and receiving a ranging response message from the target base station (TBS). Other network reentry procedures known to persons of ordinary skill in the art may also be performed. Call state information may be transferred from the source gateway (SGW) to the target gateway (TGW), as indicated by the arrow 845, and foreign agent state information may be migrated as indicated by block 850.

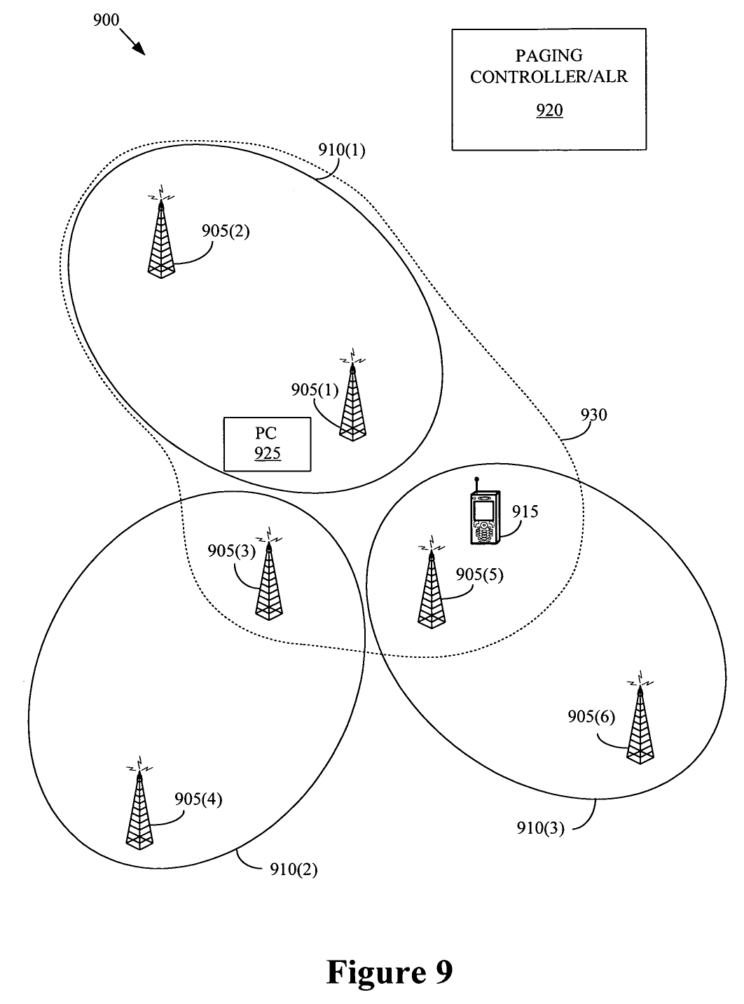

FIG. 9 conceptually illustrates a third exemplary embodiment of a distributed wireless communication network 900. In the illustrated embodiment, the network 900 operates according to the IEEE 802.16 protocol and includes a plurality of WiMAX routers (WMR) 905(1-6). The network 900 also includes a plurality of paging groups 910(1-3). In the illustrated embodiment, the paging group 910(1) includes the WiMAX routers 905(1-2), the paging group 910(2) includes the WiMAX routers 905(3-4), and the paging group 910(3) includes the WiMAX routers 905(5-6). However, persons of ordinary skill in the art should appreciate that the number of WiMAX routers 905 and paging groups 910, as well as the distribution of the WiMAX routers 905 within the paging groups 910, are matters of design choice and are not material to the present invention. The network 900 provides wireless connectivity to at least one mobile unit 915.

In the illustrated embodiment, the mobile unit 915 is in idle mode and the WiMAX router 905(1) is the last reporting router. Prior to becoming inactive, the mobile unit 915 was being served by a WMR (not shown) associated with paging controller 920. An access network location register (ALR) associated with the paging controller 920 (e.g., of the prior serving WiMAX router) keeps a record of only the last reported WMR 905(1). When a paging procedure is to be initiated, the paging controller 920 sends a single page request message to the last reporting, or target, WMR 905(1). The target WMR 905(1) forwards the paging request message to an associated paging controller 925, which may be aware of the WMRs 905(1, 2) that are within its paging group 910(1) as well as WMRs 905(3, 5) that are proximate the last reported WMR 905(1). The paging controller 925 may generate paging request messages and provide these messages to the WMRs 905(1, 2, 3, 5) in the neighbor list 930, indicated by the dashed line encircling the WMRs 905(1, 2, 3, 5) in the illustrated embodiment. The paging controller 925 may also send messages indicating that paging messages should additionally be sent by the neighboring WMRs 905(3, 5), particularly if the neighbor list for WMR 905(1) includes WMRs 905(3, 5) that are located in adjacent paging areas or groups 910(2-3). This may facilitate maintaining paging group information locally in paging controller 925 rather than in paging controller 920. In one embodiment, paging controller 925 may take into account a local deployment scenario for the neighboring WMRs 905(3, 5) whether these WMRs 905(3, 5) are deployed in the same paging group or across neighboring different groups.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of wireless communication in a network comprised of an inactive mobile unit, a plurality of gateways, and a plurality of base stations associated with the gateways, comprising:
receiving information indicative of a first base station associated with a first gateway in response to the inactive mobile unit being located in the region covered by the first base station.

2. The method of claim 1, wherein receiving the information indicative of the first base station comprises receiving a base station identifier indicative of the first base station.

3. The method of claim 1, wherein receiving the information indicative of the first base station comprises receiving information indicative of the first gateway associated with the first base station.

4. The method of claim 1, wherein receiving the information indicative of the first base station comprises receiving information indicative of the first paging controller associated with the first base station.

5. The method of claim 1, wherein receiving the information indicative of the first base station comprises receiving information indicative of the first base station in response to the inactive mobile unit moving into a region covered by the first base station in a first paging group from a region covered by the second base station in a second paging group.

6. The method of claim 1, wherein receiving the information indicative of the first base station comprises receiving the information indicative of the first base station from the first gateway.

7. The method of claim 1, comprising updating a register based on the received information indicative of the first base station.

8. The method of claim 7, comprising providing a paging signal to the first base station using the received information indicative of the first base station.

9. The method of claim 8, wherein providing the paging signal to the first base station comprises providing the paging signals to the first gateway associated with the first base station.

10. The method of claim 8, wherein providing the paging signal to the first base station comprises providing the paging signals to the first paging controller associated with the first base station.

11. The method of claim 8, wherein providing the paging signal comprises accessing the information indicative of the first base station from the register.

12. A method of wireless communication in a distributed network comprised of an inactive mobile unit, a plurality of gateways, and a plurality of base stations associated with the gateways, comprising:
providing information indicative of a first base station associated with a first gateway in response to the inactive mobile unit being located in the region covered by first base station.

13. The method of claim 12, wherein providing the information indicative of the first base station comprises providing a base station identifier indicative of the first base station.

14. The method of claim 12, wherein providing the information indicative of the first base station comprises providing information indicative of the first gateway associated with the first base station.

15. The method of claim 12, wherein providing the information indicative of the first base station comprises providing information indicative of the first paging controller associated with the first base station.

16. The method of claim 12, wherein providing the information indicative of the first base station comprises providing information indicative of the first base station in response to the inactive mobile unit entering a region covered by the first base station in a first paging group from a region covered by the second base station in a second paging group.

17. The method of claim 12, wherein providing the information indicative of the first base station comprises providing the information indicative of the first base station in response to receiving a message from the inactive mobile unit.

18. The method of claim 12, comprising receiving a paging signal from the second gateway.

19. The method of claim 18, comprising providing the paging signal to the first base station.

20. The method of claim 18, comprising providing the paging signal to at least one base station proximate the first base station.

21. The method of claim 18, comprising providing the paging signal to the inactive mobile unit.
